(19) United States
(12) Patent Application Publication
(10) Pub. No.: US 2006/0002062 A1
(43) Pub. Date: Jan. 5, 2006

(54) Latch device for portable computer

(76) Inventors: Hae Ok Kwon, Osan City (KR); Hyouk Ki Min, Pyeongtaek City (KR)

Correspondence Address: BIRCH STEWART KOLASCH & BIRCH, PO BOX 747, FALLS CHURCH, VA, 22040-0747, US

(21) Appl. No.: 11/106,523

(22) Filed: Apr. 15, 2005

(30) Foreign Application Priority Data
Jul. 2, 2004 (KR) 2004-0051684
Jul. 6, 2004 (KR) 2004-0052464

(51) Int. Cl. G06F 1/16

(52) U.S. Cl. 361/680

(57) ABSTRACT

The present invention relates to a latch device of a portable computer. The present invention provide a latch device of a portable computer having a display 30 operating to be folded onto or unfolded with respect to a main body 20 about a hinge 28, comprising a latch 60 that includes a latch body 61 with a predetermined length, hooks 64 projected from a front end of the display 30 at both ends of the latch body 31 and selectively hooked into a side of the main body 20, and a moving guide 66 with a guide slot 68 formed therein, and is installed to be translated in the display 30; an operating knob 90 that has one side thereof detachably engaged with the latch body 61 and is installed such that a knob portion 97 thereof is exposed to an outside of the display 30; and a restoring member 80 providing a force for moving the latch body 61 in a direction in which the hooks 64 are engaged with the main body 20. According to the present invention constructed as above, since the hooks of the latch for engaging the display and the main body in a portable computer with relatively large dimensions may be installed at both ends of the display, the latch makes the engagement between the display and the main body secure, and a space necessary to install the latch in the display can also be minimized.

### BACKGROUND OF THE INVENTION

1. Field of Invention

The present invention relates to a portable computer, and more particularly, to a latch device which causes a main body and a display to engage each other when the display is folded onto the main body.

2. Description of the Prior Art

FIG. 1 is a perspective view of a conventional portable computer. Referring to the figure, the portable computer comprises a main body 1 of a substantially flat rectangular shape and a display 3 which pivots about a hinge 5 at a rear end of the main body 1.

The display 3, which is formed in a plate shape corresponding to the main body 1, is folded and seated onto an upper face of the main body 1 when safekeeping or carrying the portable computer. The display 3 is unfolded with respect to the main body 1 at a predetermined angle for use, as shown in FIG. 1.

An inside of the main body 1 is provided with a mainboard and the like of the portable computer, and the upper face of the main body 1 is provided with a keyboard 7. The keyboard 7 is a portion through which desired informations are inputted as a user presses keys. The display 3 is provided with a liquid crystal panel 9 which displays various informations.

When the display 3 and the main body 1 are folded on each other to be safekept or carried, in order to engage the display 3 and the main body 1 to each other, there are provided latch devices 10. The latch devices 10 are provided at corresponding portions of front ends of a rear case 11 and a front case 12 which form an appearance of the display 3. The number of the latch devices 10 may be properly determined according to a width of the display 3.

Herein, the rear case 11 forms a rear face of the display 3, while the front case 12 forms a frame of a front edge of the display 3. The front case 12, which is formed in a rectangular frame shape, functions to seal and support an edge of the liquid crystal panel 9 of the display 3.

A space formed between the rear case 11 and the front case 12 is provided with latches and the like forming the latch devices 10. That is, the latches (not shown) are provided in the space between the rear case 11 and the front case 12 so that hooks 14 are projected in a front end of the front case 12 toward a front face. The hooks 14 are selectively hooked into catching grooves 1′ formed at a front end of the upper face of the main body 1. An operating knob 13 for operating the hook 14 is exposed to a portion corresponding to a side face of the front end of the display 3.

However, the above prior art has the following problems.

That is, the latch devices 10 are generally provided at two separate positions. Since the latch devices 10 are separately positioned, when the user unfolds the display 3 with respect to the main body 1, the operating knobs 13 provided at the respective latch devices 10 should be operated by both hands. Thus, when the display 3 is unfolded with respect to the main body 1, it is difficult to fix the main body 1. Generally, it is inconvenient that while the operating knobs 13 are operated by both thumbs the main body 1 should be fixed by some of the other fingers.

In order to solve the problem, there is provided a latch device constructed so that a latch device having two hooks is operated by a single operating knob. However, since a length of the latch is relatively elongated as the display 3 becomes large, the latch is easily bent. Thus, there are problems in that the hooks do not correctly hooked into the catching grooves, and then, a gap occurs between the main body 1 and the display 3.

Further, if the latch is relatively elongated, since the latch occupies a large inner space of the display 3, practical usability of the inner space of the display 3 is relatively reduced.

### SUMMARY OF THE INVENTION

Accordingly, the present invention is conceived to solve the aforementioned problems in the prior art. An object of the present invention is to provide a latch device which securely engages a main body and a display to each other and easily operates in case of a portable computer with relatively large dimensions.

Another object of the present invention is to provide a latch device which makes it possible to minimize a space necessary to install a latch including a plurality of hooks operated by an operating knob.

A further object of the present invention is to provide a latch device which makes it possible to minimize the number of parts of the latch.

According to an aspect of the present invention for achieving the objects, there is provided a latch device of a portable computer having a display operating to be folded onto or unfolded with respect to a main body about a hinge, comprising a latch that includes a latch body with a predetermined length, hooks projected from a front end of the display at both ends of the latch body and selectively hooked into a side of the main body, and a moving guide with a guide slot formed therein, and is installed to be translated in the display; an operating knob that has one side thereof detachably engaged with the latch body and is installed such that a knob portion thereof is exposed to an outside of the display; and a restoring member providing a force for moving the latch body in a direction in which the hooks are engaged with the main body.

The latch body may be provided with at least two moving guides.

Preferably, a fastening boss for engaging a rear case and a front case which form an appearance of the display is seated in the guide slot of the moving guide, thereby guiding the movement of the latch and defining an installation position thereof.

More preferably, the latch is installed in a rear case forming an appearance of the display, and an inner face of the rear case is provided with at least two guide hooks for guiding a side of the latch body in order to guide the movement of the latch and at least two guide pieces for guiding an opposite side of the latch body which is guided by the guide hooks.

Still more preferably, a front end of each of the guide hooks is formed with a catching projection to prevent the latch body from moving in a direction in which the latch body is separated from the inner face of the rear case, and steps of the latch body in which the catching projections are seated are formed to be relatively lower than the other portions of the latch body.

Still more preferably, a guide stopper is formed, at an end side of the latch body to which is connected to the restoring member, in the rear case so as to guide a surface of the latch body and a surface thereof perpendicular thereto, thereby guiding the movement of the latch body and defining an installation position thereof.

The operating knob may comprise a knob body provided with a catching hook for engaging with the latch body; the knob portion provided at a side of the knob body and exposed to the outside of the display; and an assembly guide pin for guiding an insertion direction of the knob body.

Preferably, a rear case forming an appearance of the display is formed with a plurality of supporting knobs on which the latch body is seated, and the supporting knobs are formed such that the latch body is positioned at a constant level as a whole regardless of the shape of the rear case.

According to the present invention constructed as above, since the hooks of the latch for engaging the display and the main body in a portable computer with relatively large dimensions may be installed at both ends of the display, the latch makes the engagement between the display and the main body secure, and a space necessary to install the latch in the display can also be minimized.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a perspective view showing a conventional portable computer;

FIG. 2 is an exploded perspective view showing a major portion of a first embodiment of a portable computer to which a latch device according to the present invention is applied;

FIG. 3a is a front view showing a latch according to a first embodiment of the present invention;

FIG. 3b is a side view showing the latch according to the first embodiment of to the present invention;

FIG. 3c is a sectional view showing an inside of the latch according to the first embodiment of the present invention;

FIG. 4 is a sectional view showing the major portion of the first embodiment of the present invention;

FIGS. 5a to 5c are views showing processes of assembly and operation of the first embodiment of the present invention;

FIG. 6 is an exploded perspective view showing a major portion of a portable computer to which a latch device according to a second embodiment of the present invention is applied;

FIG. 7 is a plan view showing the major portion of the second embodiment according to the present invention;

FIG. 8a is a front view showing a latch according to the second embodiment of the present invention;

FIG. 8b is a plan view showing the latch according to the second embodiment of the present invention;

FIG. 9a is a view showing the second embodiment of the present invention which is installed in place; and

FIG. 9b is a view showing an operation of the second embodiment of the present invention.

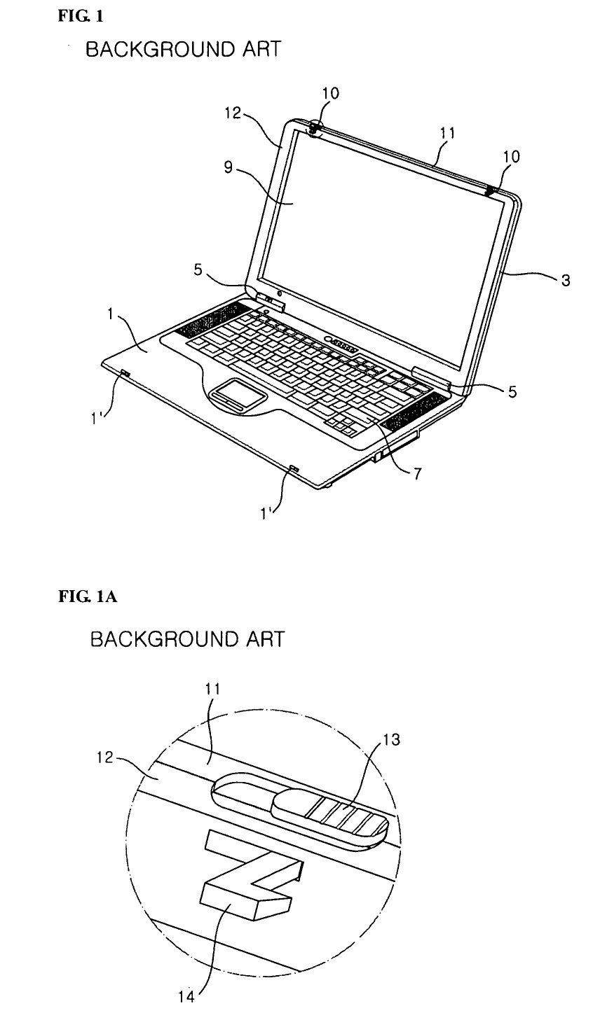

### DETAILED DESCRIPTION OF THE PREFERRED EMBODIMENT

Hereinafter, preferred embodiments of the present invention will be described in detail with reference to the accompanying drawings.

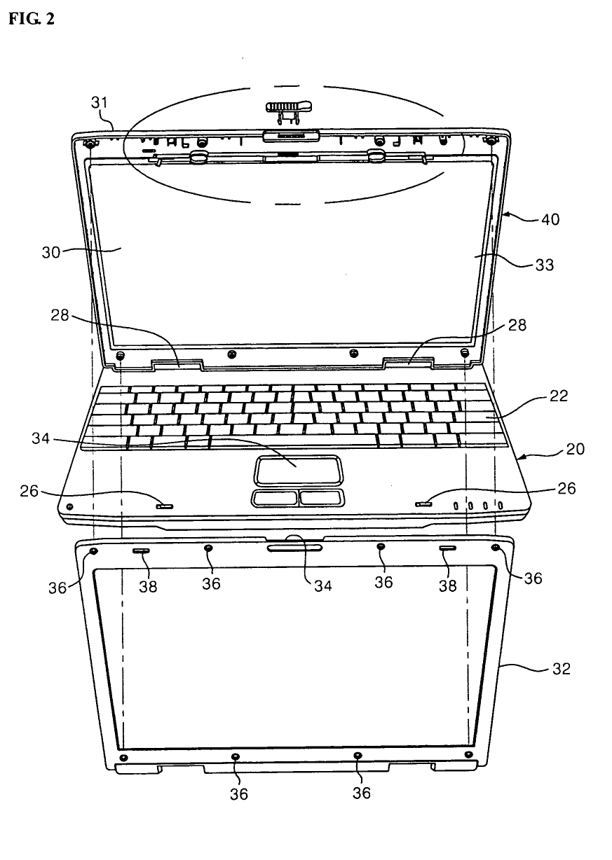

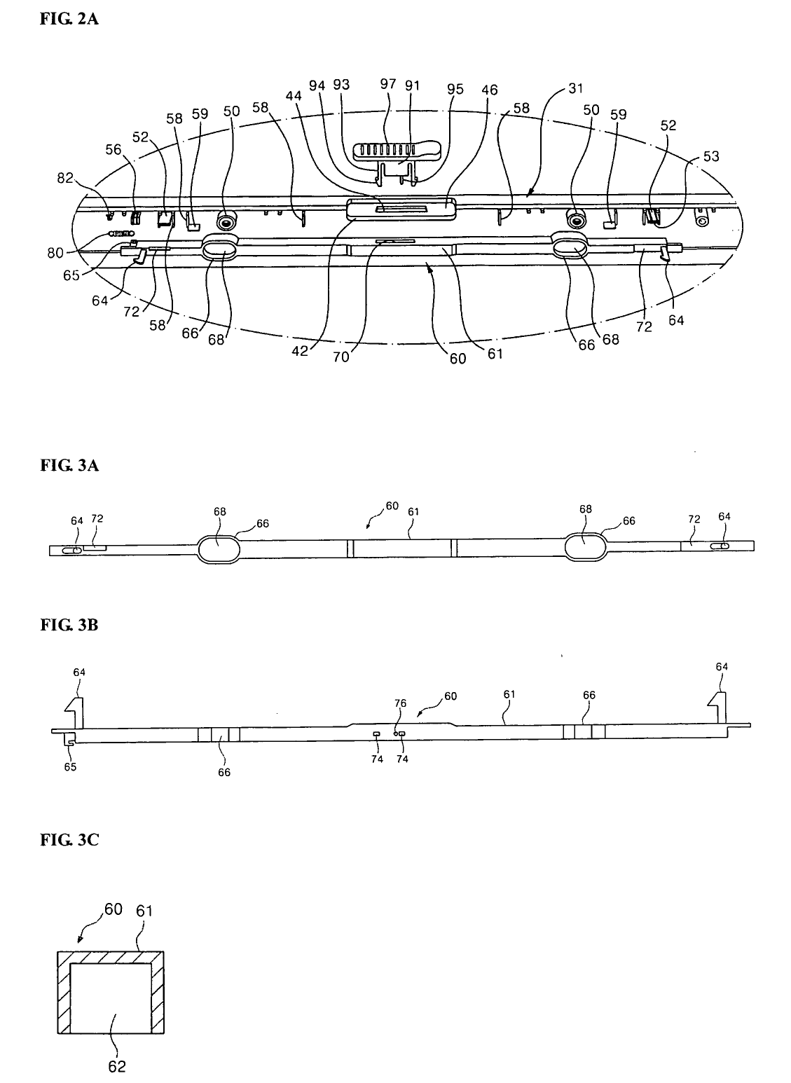

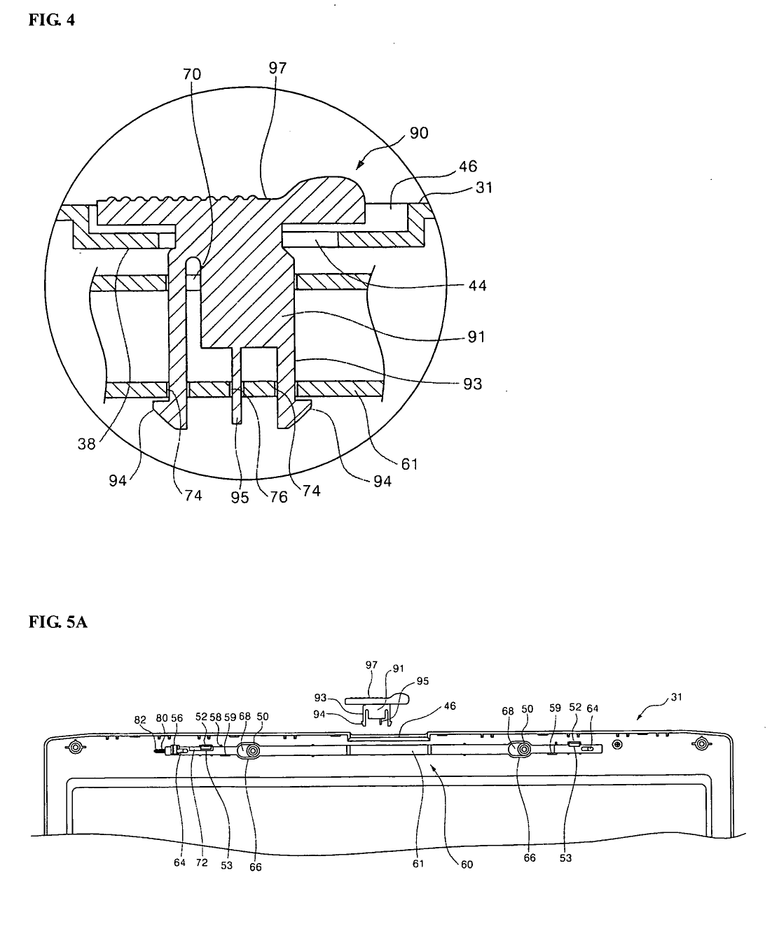

FIG. 2 is an exploded perspective view showing a portable computer to which a first embodiment of a latch device according to the present invention is applied. FIGS. 3a to 3c are front, side and sectional views showing a latch according to the first embodiment of the present invention. FIG. 4 is a sectional view showing a major portion of the first embodiment of the present invention.

Referring to these figures, various parts are installed in a main body 20 of the portable computer, which is formed in a substantially rectangular plate shape. An upper face of the main body 20 is provided with a keyboard 22. A center of a front end of the upper face of the main body 20 is provided with a touchpad 24 which is a pointing device.

Both sides of the front end of the upper face of the main body 20 are provided with catching grooves 26. The catching grooves 26 are portions into which hooks 64 for engaging the main body 20 and a display 30 are hooked.

The display 30 is pivotably connected to a rear end of the main body 20 through a hinge 28. The display 30 pivots about the hinge 28 to be folded onto the main body 20 or unfolded with respect thereto at a predetermined angle.

An appearance of the display 30 is formed by a rear case 31 and a front case 32. The rear case 31 forms a rear face of the display 30, while the front case 32 of a rectangular frame shape forms a front edge of the display 30. The rear case 31 is preferably formed of synthetic resin and not metal in the present embodiment, while an inside thereof except a portion of its front end comprises metal plates.

An inside of the display 30 is provided with a liquid crystal panel 33 the edge of which is sealed by the front case 32. The liquid crystal panel 33 displays image information. Instead of the liquid crystal panel 33, various display panels may be employed.

An evading portion 34 which forms a side of a knob seating groove 46 provided in the rear case 31 is concavely formed at a rear face of a front end of the front case 32. The front case 32 may also be formed of synthetic resin, and is temporarily assembled to the rear case 31 by means of hook-shaped portions.

A plurality of fastening holes 36 for fastening the front case 32 to the rear case 31 are formed through the front case 32. Hook slots 38 are formed through the front end of the front case 32. The hooks 64 of a latch 60, which will be described below, are projected through the hook slots 38. The hook slots 38 are preferably positioned relatively adjacent to both ends of the front case 32.

An inside of a front end of the rear case 31 is provided with a structure for installing the latch 60 and guiding the movement of the latch 60, which will be described. First, a side wall 40 having a predetermined height is provided around an edge of the rear case 31, wherein a projecting piece 42 is relatively projected and is formed at a center of the front end of the rear case 31. The projecting piece 42 is also stepped relatively inside of the rear case 31 as compared with the other portion of the side wall 40. The projecting piece 42 is formed with an elongated knob guide slot 44. The knob seating groove 46 is completed by engaging the evading portion 34 of the front case 32 to the projecting piece 42.

A plurality of fastening bosses 50 are provided in the front end of the rear case 31. The fastening bosses 50 are formed at positions corresponding to the fastening holes 36 of the front case 32. A fastening aperture in which a thread is formed is vertically formed through a center of each fastening boss 50.

An inner face of the front end of the rear case 31 is provided with guide hooks 52. The guide hooks 52 are projected vertically from the inner face of the rear case 31, wherein a catching projection 53 extends at a right angle from a front end of each guide hook 52. The catching projections 53 are seated on a side of the latch 60, which will be described below, and then, define an installation position of the latch 60 and guide movement thereof. The guide hooks 52 are formed not to interfere with the latch 60 along a movement trace of the latch 60.

The inner face of the front end of the rear case 31 is provided with a guide stopper 56 not to interfere with the latch 60 on the movement trace of the latch 60. The guide stopper 56 vertically extends from the inner face of the rear case 31, and then extends by a predetermined length from its front end in parallel with the inner face so as to define the installation position of the latch 60 and guide the movement of the latch 60.

Further, the inner face of the front end of the rear case 31 is provided with a plurality of supporting knobs 58 along the movement trace of the latch 60. The supporting knobs 58 are in direct contact with a side of the latch 60, and then, support it. The supporting knobs 58 are formed to be elongated perpendicularly to the moving direction of the latch 60, wherein the degree of projection thereof from the inner face of the rear case 31 can vary. This is to compensate a curved surface having some curvature of the front end of the rear case 31 when it is formed in the curved surface. Therefore, if the corresponding portions of the rear case 31 are flat, the supporting knobs 58 need not be provided.

Guide pieces 59 are formed in order to guide both opposite surfaces of the latch 60 guided by the guide hooks 52 or the guide stopper 56. The guide pieces 59 are provided at positions corresponding to between the fastening bosses 50 and the guide hooks 52. The guide pieces 59 are formed so as to be projected vertically from the inner surface of the rear case 31.

A latch body 61 of the latch 60 is formed in an elongated bar shape. The latch body 61 has a length corresponding to at least a distance between the hook slots 38 of the front case 32. The latch body 61 has a cross section of a substantially rectangular shape and is formed to be hollow and opened to a face thereof. An inside of the latch body 61 is provided with a plurality of partitions 62 for reinforcing the latch body 61.

Both ends of the latch body 61 are formed with the hooks 64. A front end of each hook 64 is projected at a predetermined length in a direction of the length of the latch body 61, and then, is selectively hooked into each catching groove 26 of the main body 20. It is preferred that the hooks 64 be formed at positions adjacent to both the ends of the latch body 61.

An end of the latch body 61 is formed with a restoring member hook 65. An end of a restoring member 80, which will be described below, is hooked onto the restoring member hook 65, causing an elastic force to be applied to the latch body 61.

At least two positions of the latch body 61 are formed with respective moving guides 66. The moving guides 66 are formed in an intermediate portion of the latch body 61, wherein a guide slot 68 is vertically formed through an inside of each moving guide 66. The fastening bosses 50 are positioned in the guide slots 68, respectively. Therefore, the movement of the latch 60 is guided by the guide slots 68 and the fastening bosses 50. To this end, the guide slot 68 is formed to be elongated more than a diameter of the fastening bosses 50, providing a stroke for the hooks 64 to be hooked into or unhooked from the catching grooves 26.

A knob fixing slot 70 is formed through a corresponding face of the center of the latch body 61. The knob fixing slot 70 is formed on a surface perpendicular to a surface in which the hooks 64 are formed. That is, the knob fixing slot 70 is formed at a position corresponding to the knob guide slot 44 of the knob seating groove 46.

The latch body 61 is formed with steps 72 at positions corresponding to the guide hooks 52, respectively. The steps 72 are formed relatively lower than the other portions of the latch body 61. Therefore, the catching projections 53 of the guide hooks 52 are seated in the steps 72, respectively, and then, guide the movement of the latch body 61. At least one of the steps 72 is preferably formed over an area corresponding to the movement trace of the latch body 61.

As shown in FIG. 4, the latch body 61 is formed with hook holes 74 and a guide hole 76 at a portion corresponding to the knob fixing slot 70. An assembly guide pin 95 and catching hooks 93 of an operating knob 90, which will be described below, are inserted into the guide hole 76 and the hook holes 74, respectively. The guide hole 76 is formed at a position more adjacent to any one of the hook holes 74.

The restoring member 80 functions to pull the latch 60 in a certain direction. The restoring member 80 may comprise a tensile coil spring. The restoring member 80 generates the elastic force in the direction in which the hooks 64 of the latch 60 are hooked into the catching grooves 26 of the main body 20.

A side of the rear case 31 is formed with a catching portion 82. The catching portion 82 is a portion onto which the other end of the restoring member 80 is hooked. The catching portion 82 is formed at a position spaced apart by a predetermined distance from an end of the movement trace of the latch 60.

The operating knob 90 is a portion to which a force for moving the latch 60 is transmitted. A knob body 91 of the operating knob 90 is positioned at the inside of the rear case 31 corresponding to a lower portion of the projecting piece 42. Both ends of the knob body 91 are provided with the catching hooks 93, which pass through the knob fixing slot 70 and then are hooked into the hook holes 74, respectively. A front end of each of the catching hooks 93 is provided with a catching projection 94 and is hooked into the hook hole 74 with some elastic deformation.

A side of the knob body 91 is formed with the assembly guide pin 95. The assembly guide pin 95 extends by a predetermined length in parallel with the extending direction of the catching hooks 93 and formed to be biased toward any one of the catching hooks 93. The assembly guide pin 95 functions to guide the direction of assembling the operating knob 90 to the latch 60.

A side of the knob body 91 is provided with a knob portion 97. The knob portion 97, the surface of which is preferably provided with a means for preventing a slip, is seated in the knob seating groove 46. The knob portion 97 is a portion through which a user operates the operating knob 90.

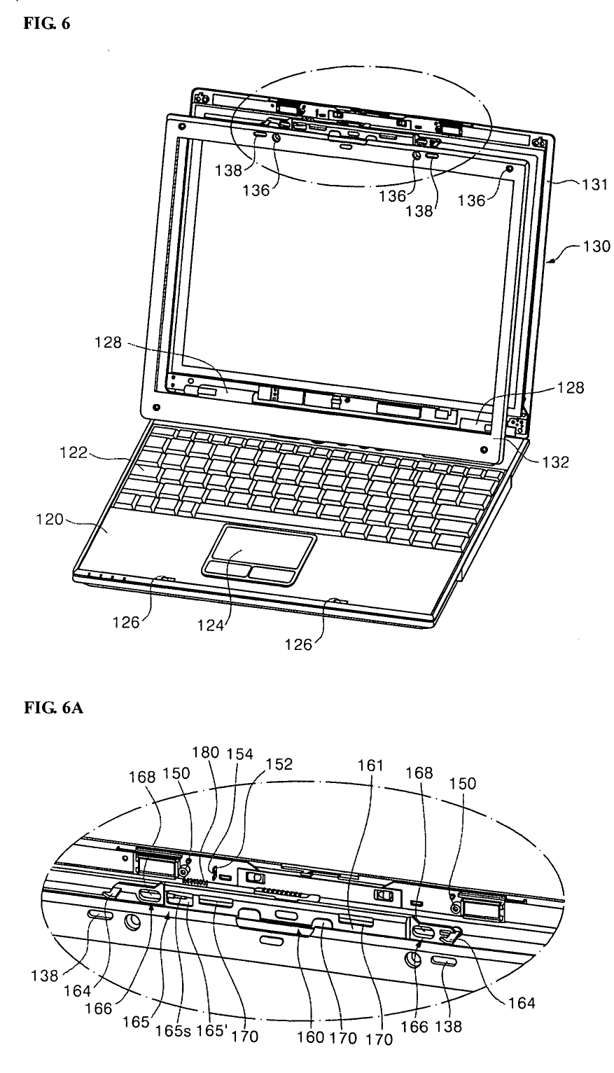

Next, a second embodiment of present invention is shown in FIGS. 6 to 8a and 8b. According to the figures, various parts are installed in a main body 120 of the portable computer, which is formed in a substantially rectangular plate shape. An upper face of the main body 120 is provided with a keyboard 122. A center of a front end of the upper face of the main body 120 is provided with a touchpad 124 which is a pointing device.

Both sides of the front end of the upper face of the main body 120 are provided with catching grooves 126. The catching grooves 126 are portions into which hooks 164 for engaging the main body 120 and a display 130 are hooked.

The display 130 is pivotably connected to a rear end of the main body 120 through a hinge 128. The display 130 pivots about the hinge 128 to be folded onto the main body 120 or unfolded with respect thereto at a predetermined angle.

An appearance of the display 130 is formed by a rear case 131 and a front case 132. The rear case 131 forms a rear face of the display 130, while the front case 132 of a rectangular frame shape forms a front edge of the display 130. The rear case 131 is preferably formed of synthetic resin and not metal in the present embodiment, while an inside thereof except a portion of its front end comprises metal plates.

An inside of the display 130 is provided with a liquid crystal panel 133 the edge of which is sealed by the front case 132. The liquid crystal panel 133 displays image information. Instead of the liquid crystal panel 133, various display panels may be employed.

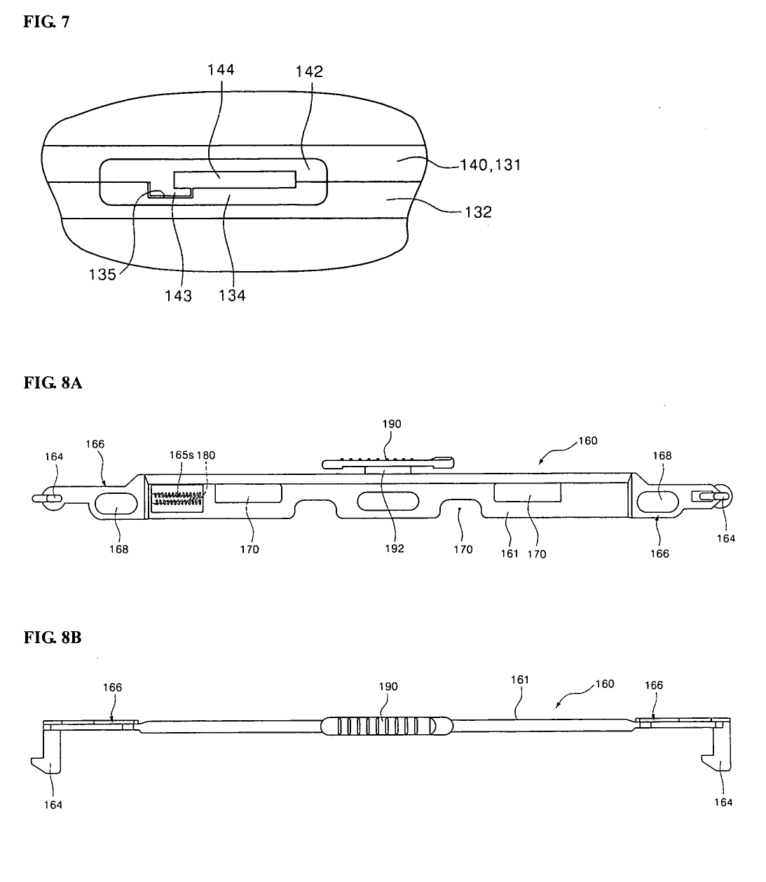

As shown in FIG. 7, a curved surface having a predetermined width in a direction of the rear case 131 is formed around an edge of the front case 132, wherein a center of a front end of the front case 132 in the curved surface is formed with a concave groove 134. A side of the concave groove 134 is provided with an evading slot 135. A projecting piece 143, which will be described below, is seated in the evading slot 135.

The front case 132 may be provided with a plurality of hook-shaped portions for temporary assembly with the rear case 131. A plurality of fastening holes 136 for securely fastening the front case 132 to the rear case 131 are formed through the front case 132. Hook slots 138 are formed through the front end of the front case 132. Hooks 164 of a latch 160, which will be described below, are projected through the hook slots 138. The hook slots 138 are preferably positioned relatively adjacent to both ends of the front case 132.

An inside of a front end of the rear case 131 is provided with a structure for installing the latch 160 and guiding the movement of the latch 160, which will be described. First, an antenna cover 140 is installed at an edge of the front end of the rear case 131. The antenna cover 140 is formed with a curved surface toward the front case 132. The curved surfaces of the antenna cover 140 and the front case 132 cooperate with each other to form a front face of the display 130. For reference, the antenna cover 140 may be integrally formed in the rear case 131. However, in the present embodiment, the antenna cover 140 is formed separately from the rear case 131, and is engaged with the rear case 131 so as to form a portion of the rear case 131.

The antenna cover 140 is formed with a concave groove 142 at a position corresponding to the concave groove 134 of the front case 132. The projecting piece 143 is projected and formed in a side in which the concave groove 142 is formed. The projecting piece 143 is positioned at the evading slot 135 of the front case 132. The projecting piece 143 forms an end of a knob-moving slot 144, which will be described below, and then, is hooked onto a connecting neck 192 of an operating knob 190 in order to temporarily assemble the latch 160 when the latch 160 which will be described below is assembled.

If the concave groove 134 of the front case 132 and the concave groove 142 of the antenna cover 140 are engaged with each other, a groove in which the operating knob 190 which will be described below is seated is formed. In addition, since some of portions in which the concave grooves 134 and 142 of the front case 132 and the antenna cover 140 are formed are relatively less projected, the knob-moving slot 144 is formed by engaging the front case 132 and the antenna cover 140 to each other. Herein, the projecting piece 143 forms a portion of the knob-moving slot 144 at a side of the front case 132.

A plurality of fastening bosses 150 are provided in the front end of the rear case 131. The fastening bosses 150 are formed at positions corresponding to the fastening holes 136 of the front case 132. The fastening aperture in which a thread is formed is vertically formed through the center of each fastening boss 150.

The inside of the front end of the rear case 131 is formed with a restoring member support 152. The restoring member support 152 is formed with a guide slot 154. The guide slot 154 is formed through the restoring member support 152 and opened to an upper end of the restoring member support 152.

A latch body 161 of the latch 160 is formed in an elongated bar shape. The latch body 161 has a length corresponding to at least a distance between the hook slots 138 of the front case 132. The latch body 161 is formed in a substantially elongated plate shape.

Both ends of the latch body 161 are formed with the hooks 164. A front end of each hook 164 is projected at a predetermined length in the direction of the length of the latch body 161, and then, is selectively hooked into each catching groove 126 of the main body 120. It is preferred that the hooks 164 be formed at positions adjacent to both the ends of the latch body 161.

An end of the latch body 161 is formed with a restoring member hook 165. An end of a restoring member 180, which will be described below, is hooked onto the restoring member hook 165, causing an elastic force to be applied to the latch body 161. In the restoring member hook 165, a hook rod 165s is formed in the direction of the length of the latch body 161 in a hook penetrating section 165′ which is formed through the latch body 161. The hook rod 165s is shorter than the hook penetrating section 165′.

At least two positions of the latch body 161 are formed with respective moving guides 166. The moving guides 166 are formed in an intermediate portion of the latch body 161, wherein a guide slot 168 is vertically formed through an inside of each moving guide 166. The fastening bosses 150 are positioned in the guide slots 168, respectively. Therefore, the movement of the latch 160 is guided by the guide slots 168 and the fastening bosses 150. To this end, the guide slot 168 is formed to be elongated more than a diameter of the fastening bosses 150, providing a stroke for the hooks 164 to be hooked into or unhooked from the catching grooves 126.

The latch body 161 is provided with a plurality of interference avoiding portions 170 for preventing interference with parts installed around the latch 160. While some of the interference avoiding portions 170 are formed through the center of the latch body 161, the others are cut off to be opened to a side of the latch body 161.

The restoring member 180 functions to pull the latch 160 in a certain direction. The restoring member 180 may comprise a compressive coil spring. The restoring member 180 generates the elastic force in the direction in which the hooks 164 of the latch 160 are hooked into the catching grooves 126 of the main body 120.

The operating knob 190 is a portion to which a force for moving the latch 160 is transmitted. The operating knob 190 is formed integrally with the latch body 161 in the present embodiment. The connecting neck 192 is provided between the operating knob 190 and the latch body 161. The connecting neck 192 is positioned in the knob-moving slot 144. A surface of the operating knob is preferably provided with a means for preventing a slip.

Hereinafter, an operation of the latch device of the portable computer according to the present invention constructed as above will be described in detail.

First, in the first embodiment, an assembly process of the latch 60 and the operating knob 90 will be described. The latch 60 is seated in the inner face of the front end of the rear case 31. That is, the movement of the latch 60 is guided by the fastening bosses 50, the guide hooks 52, the guide stopper 56 and the guide pieces 59.

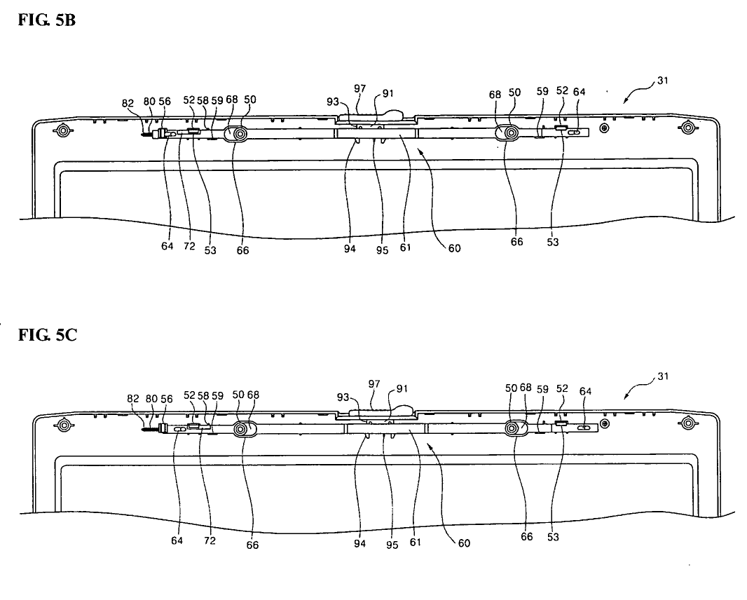

The fastening bosses 50 are seated in the guide slots 68 of the moving guides 66 of the latch 60, respectively. The guide hooks 52 are brought into contact with a surface of the latch body 61 and a surface perpendicular thereto, respectively. Particularly, the catching projections 53 of the guide hooks 52 are seated on the steps 72, respectively. The guide stopper 56 functions to guide a surface of the latch body 61 at the end of the latch body 61, and at the same time, guide the latch body 61 not to move in the direction opposite to the inner face of the rear case 31. The guide pieces 59 are in contact with a surface of the latch body 61 which is opposite to the guide hooks 52 and the guide stopper 56. Such a state is shown in FIG. 5a.

The end of the restoring member 80 is caught onto the restoring member hook 65 at the end of the latch body 61. The other end of the restoring member 80 is caught onto the catching portion 82 of the rear case 31, so that the restoring member 80 always pull the latch body 61 left with respect to FIG. 5a.

Next, the operating knob 90 is mounted in the latch body 61. The operating knob 90 passes through the knob guide slot 44 of the knob seating groove 46, and then, the knob body 91 is inserted thereinto. At this time, the knob portion 97 is seated onto an upper face of the projecting piece 42. The knob body 91 of the operating knob 90, which passes through the knob guide slot 44, is inserted into the knob fixing slot 70 formed in the latch body 61.

Then, the catching hooks 93 formed in the knob body 91 are hooked into the hook holes 74, respectively. At this time, the assembly guide pin 95 is inserted into the guide hole 76. If the operating knob 90 is assembled reversely, the assembly guide pin 95 cannot be inserted into the guide hole 76. It is the reason why the assembly guide pin 95 is formed relatively more adjacent to the one of the catching hooks 93 and the guide hole 76 is also formed more adjacent to the one of the hook holes 74. The assembled state of the operating knob 90 is shown in FIG. 5b.

In addition, after all necessary parts such as the liquid crystal panel 33 are installed in the display 30, the front case 32 is assembled. The front case 32 and the rear case 31 are temporarily assembled by the hook-shaped portions, and then, engaged to each other by tightening screws, which pass through the fastening holes 36, to the fastening bosses 50.

Next, an operation of the latch device of the first embodiment of the present invention will be described. When the display 30 is folded onto the main body 20, front ends of the hooks 64 are guided along one sides of the catching grooves 26, respectively, and then, the latch body 61 moves right with respect to the figure, while overcoming the elastic force of the restoring member 80.

Then, if the hooks 64 are fully hooked into the catching grooves 26, the latch body 61 moves to its initial position by the elastic force of the restoring member 80, and the main body 20 and the display 30 are engaged to each other.

In such a state, in order to release the engagement of the main body 20 and the display 30, the user should operate the operating knob 90. That is, the knob portion 97 of the operating knob 90 is caused to move in the knob seating groove 46. If the operating knob 90 moves, the latch 60 moves together. Thus, the latch body 61 moves while guided by means of the fastening bosses 50, the guide hooks 52, the guide stopper 56 and the guide pieces 59. At this time, the latch body 61 moves while overcoming the elastic force of the restoring member 80.

Due to the movement of the latch body 61, the engagement between the hooks 64 and the catching grooves 26 is released. Although the movement of the latch body 61 causes the engagement to be simply released, the hooks 64 do not get out of the catching grooves 26. That is, if the user rotates the display 30 about the hinge 28 with respect to the main body 20, the hooks 64 get out of the catching grooves 26.

In addition, if the user removes a force applied to the operating knob 90, the latch body 61 moves to its initial position shown in FIG. 5b by the elastic force of the restoring member 80.

Next, in the second embodiment of the present invention, the latch 160 is installed in the rear case 131 so that the fastening bosses 150 are seated in the guide slots 168 of the moving guides 166, respectively. At this time, the operating knob 190 integrally formed in the latch body 161 is seated in the concave groove 142 with a portion of the connecting neck 192 hooked in the projecting piece 143 of the antenna cover 140. Here, the projecting piece 143 functions to make the latch body 161 be temporarily assembled.

Then, in the latch 160, the restoring member hook 165 is previously provided with the restoring member 180. The restoring member 180 has been caught onto the hook rod 165s. With the restoring member 180 caught onto the hook rod 165s, the other end of the restoring member 180 is supported by the restoring member support 152. Since the hook rod 165s is positioned in the guide slot 154, the hook rod 165s does not interfere with the restoring member support 152 when the latch body 161 moves.

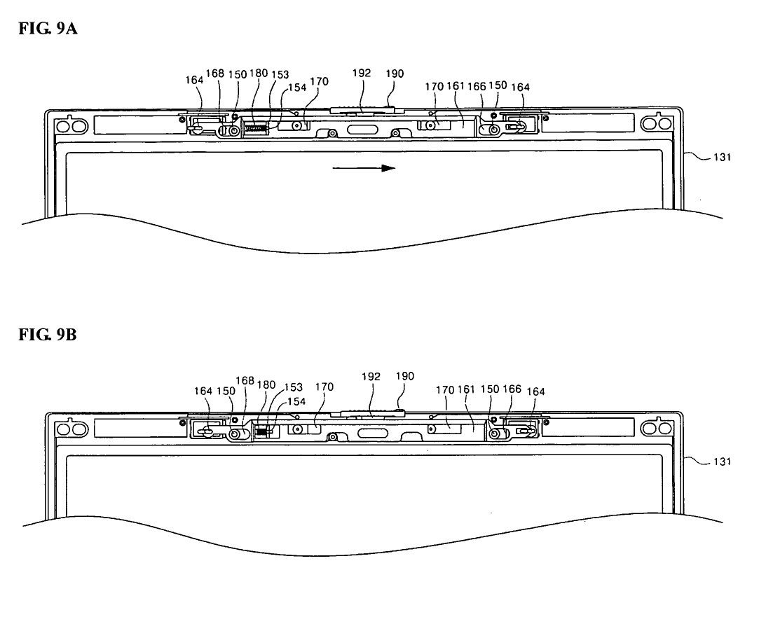

Accordingly, the latch body 161 tends to move in the direction opposite to an arrow shown in FIG. 9a, that is, the direction in which the hooks 164 are hooked into the catching grooves 126, by the elastic force of the restoring member 180.

Then, the front case 132 is engaged to the rear case 131. The hooks 164 should be projected through the hook slots 138. Of course, it is performed after the various parts of the display 130 are installed into the rear case 131. The front case 132 and the rear case 131 are engaged to each other by tightening screws, which pass through the fastening holes 136, to the fastening bosses 150.

Next, an operation of the latch device of the second embodiment of the present invention will be described. When the display 130 is folded onto the main body 120, front ends of the hooks 164 are guided along one sides of the catching grooves 126, respectively, and then, the latch body 161 moves right with respect to FIG. 9a, while overcoming the elastic force of the restoring member 180.

Further, if the hooks 164 are fully hooked into the catching grooves 126, the latch body 161 moves to its initial position by the elastic force of the restoring member 180, and then, the main body 120 and the display 130 are engaged to each other.

In such a state, in order to release the engagement of the main body 120 and the display 130, the user should operate the operating knob 190. That is, the operating knob 190 is caused to move in the concave grooves 134 and 142. If the operating knob 190 moves, the latch 160 moves together. Since the fastening bosses 150 are positioned in the guide slots 168 of the moving guides 166, the fastening bosses 150 are guided by the guide slots 168, causing the movement of the latch body 161 to be guided.

At this time, the latch body 161 moves while overcoming the elastic force of the restoring member 180. Due to the movement of the latch body 161, the engagement between the hooks 164 and the catching grooves 126 is released. Such a state is shown in FIG. 9b.

Although the movement of the latch body 161 causes the engagement to be simply released, the hooks 164 do not get out of the catching grooves 126. That is, if the user rotates the display 130 about the hinge 128 with respect to the main body 120, the hooks 164 get out of the catching grooves 126.

In addition, if the user removes a force applied to the operating knob 190, the latch body 161 moves to its initial position shown in FIG. 9a by the elastic force of the restoring member 180.

According to the latch device of the portable computer of the present invention as described above, the following advantages can be expected.

The latch device of the present invention is constructed so that the latch body having two hooks is operated by the single operating knob. Thus, the user can release the engagement of the main body and the display by only one hand, causing the operation to be relatively easy.

Further, in the present invention, at least two moving guides are formed in the intermediate portion of the latch body, and the fastening bosses of the rear case are seated in the guide slots formed in the moving guides. Thus, the movement of the latch body is guided, and at the same time, the latch body can be securely positioned in the rear case. Accordingly, since the latch body may be relatively elongated, the hooks are positioned at both ends of the display with relatively large dimensions so that the main body and the display can be securely engaged to each other.

In the meantime, since the fastening bosses positioned in the guide slots of the latch body also function to fasten the rear case and the front case to each other, an inner space of the display can be effectively used. Particularly, the installation position of the latch body can be securely defined while the fastening bosses are engaged to the front case.

In addition, according to the present invention, since the operating knob is formed integrally with the latch, the number of the parts of the latch can be reduced, and then, an assembling process thereof can be simplified, causing manufacturing costs to be reduced.

The scope of the present invention is not limited to the embodiments described and illustrated above but is defined by the appended claims. It will be apparent that those skilled in the art can make various modifications and changes thereto within the scope of the invention defined by the claims.

For example, the order of the fastening bosses 50, the guide hooks 52, the guide stopper 56 and the guide pieces 59 is not important if the movement of the latch body 61 can be guided.

Furthermore, although the latch 60 is installed in the rear case 31 in the first embodiment of the present invention, a portion in which the latch 60 is installed may be the antenna cover (not shown), which is provided at the front end of the rear case 31 and then forms a portion of the rear case 31.

Also, the knob-moving slot 144 for moving the operating knob 190 is formed by the front case 132 and the antenna cover 140 in the second embodiment of the present invention, but not necessarily so. If the antenna cover 140 is integrated with the rear case 131, the knob-moving slot is formed by the rear case 131 and the front case 132.

What is claimed is:

1. A latch device of a portable computer having a display operating to be folded onto or unfolded with respect to a main body about a hinge, comprising:
a latch including a latch body with a predetermined length, hooks projected from a front end of the display at both ends of the latch body and selectively hooked into a side of the main body, and a moving guide with a guide slot formed therein, the latch being installed to be translated in the display;
an operating knob having one side thereof detachably engaged with the latch body, the operating knob being installed such that a knob portion thereof is exposed to an outside of the display; and
a restoring member providing a force for moving the latch body in a direction in which the hooks are engaged with the main body.

2. The latch device as claimed in claim 1, wherein the latch body is provided with at least two moving guides.

3. The latch device as claimed in claim 2, wherein a fastening boss for engaging a rear case and a front case which form an appearance of the display is seated in the guide slot of the moving guide, thereby guiding the movement of the latch and defining an installation position thereof.

4. The latch device as claimed in claim 1, wherein the latch is installed in a rear case forming an appearance of the display, and an inner face of the rear case is provided with at least two guide hooks for guiding a side of the latch body in order to guide the movement of the latch and at least two guide pieces for guiding an opposite side of the latch body which is guided by the guide hooks.

5. The latch device as claimed in claim 4, wherein a front end of each of the guide hooks is formed with a catching projection to prevent the latch body from moving in a direction in which the latch body is separated from the inner face of the rear case, and steps of the latch body in which the catching projections are seated are formed to be relatively lower than the other portions of the latch body.

6. The latch device as claimed in claim 5, wherein a guide stopper is formed, at an end side of the latch body which is connected to the restoring member, in the rear case so as to guide a surface of the latch body and a surface thereof perpendicular thereto, thereby guiding the movement of the latch body and defining an installation position thereof.

7. The latch device as claimed in claim 1, wherein the operating knob comprises:
a knob body provided with a catching hook for engaging with the latch body;
the knob portion provided at a side of the knob body and exposed to the outside of the display; and
an assembly guide pin for guiding an insertion direction of the knob body.

8. The latch device as claimed in any one of claims 1 to 7, wherein a rear case forming an appearance of the display is formed with a plurality of supporting knobs on which the latch body is seated, the supporting knobs being formed such that the latch body is positioned at a constant level as a whole regardless of the shape of the rear case.

9. A latch device of a portable computer having a display operating to be folded onto or unfolded with respect to a main body about a hinge, comprising:
a latch including a latch body with a predetermined length, hooks projected from a front end of the display at both ends of the latch body and selectively hooked into a side of the main body, and a moving guide with a guide slot formed therein, the latch being installed to be translated in the display;
an operating knob integrally provided in the latch body, the operating knob being partially exposed to an outside of the display in order to receive user's operating force; and
a restoring member providing a force for moving the latch body in a direction in which the hooks are engaged with the main body.

10. The latch device as claimed in claim 9, wherein the latch body is provided with at least two moving guides.

11. The latch device as claimed in claim 10, wherein a fastening boss for engaging a rear case and a front case which form an appearance of the display is seated in the guide slot of the moving guide, thereby guiding the movement of the latch and defining an installation position thereof.

12. The latch device as claimed in claim 9, wherein a restoring member hook for installing the restoring member thereon is formed through a portion of the latch body.

13. The latch device as claimed in claim 12, wherein the restoring member hook comprises a hook penetrating section formed through the latch body, and a hook rod extending by a predetermined length in a direction of the length of the latch body in the hook penetrating section, the hook rod being fitted around the restoring member.

14. The latch device as claimed in claim 13, wherein an inner face of the rear case is formed with a restoring member support positioned at an end of the restoring member hook to support an end of the restoring member, the restoring member support being formed with a guide slot through which the hook rod passes according to the movement of the latch body.

15. The latch device as claimed in claim 9, wherein the operating knob is seated in a space formed by concave grooves formed in a rear case and a front case which form an appearance of the display, the concave grooves being formed with a knob-moving slot by means of engagement of the rear case and the front case.

16. The latch device as claimed in claim 15, wherein a front end of the rear case is formed of an antenna cover, and a portion in which the concave grooves are formed is provided in the antenna cover.

17. The latch device as claimed in claim 15 or 16, wherein the rear case or the antenna cover is provided with a projecting piece forming an end of the knob-moving slot, so that the latch is temporarily assembled.
